(19) United States
(12) Patent Application Publication
(10) Pub. No.: US 2014/0347007 A1
(43) Pub. Date: Nov. 27, 2014

(54) Wireless Power Transfer (WPT) for a Mobile Communication Device

(71) Applicant: Broadcom Corporation, Irvine, CA (US)

(72) Inventors: Scott Kee, Mission Viejo, CA (US); Ichiro Aoki, Irvine, CA (US); Setu Mohta, Fullerton, CA (US); Jesal Mehta, Irvine, CA (US); Vadim Bishtein, Sunnyvale, CA (US); David Lin, San Jose, CA (US)

(73) Assignee: Broadcom Corporation, Irvine, CA (US)

(21) Appl. No.: 14/286,347

(22) Filed: May 23, 2014

Related U.S. Application Data
(60) Provisional application No. 61/826,938, filed on May 23, 2013.
(60) Provisional application No. 61/826,932, filed on May 23, 2013.

(51) Int. Cl. H02J 7/02

(52) U.S. Cl. CPC H02J 7/025; H02J 2007/0096
USPC 320/108

(57) ABSTRACT

A wireless power transfer (WPT) station is disclosed for wirelessly transferring power to a WPT enabled device. To initiate charging of the WPT enabled device, the WPT enabled device is simply moved to be proximate to the WPT station. After an initialization and setup period, the WPT station transmits power transfer signals to the WPT enabled device. The WPT enabled device receives the transferred power transfer signals, typically through inductive coupling, and extracts a voltage and/or current therefrom for charging. The extracted voltage and/or current can then be rectified and/or regulated by the WPT enabled device to produce a charging voltage and/or charging current that can be stored in a power storage element, such as a battery or a capacitor to provide some examples, of the WPT enabled device.

### CROSS REFERENCE TO RELATED APPLICATIONS

This application claims the benefit of provisional application No. 61/826.938, filed on May 23, 2013, and provisional application No. 61/826,932, filed on May 23, 2013, each of which is incorporated herein by reference in its entirety.

### FIELD OF THE DISCLOSURE

The present disclosure relates generally to wireless power transfer including wireless power transfer in mobile communication devices.

### BACKGROUND

Wireless power transfer, also referred to as wireless energy transmission or wireless power, is an emerging technological avenue that presently being explored by manufacturers of electronic devices. Wireless power transfer allows these electronic devices, as well as other devices, to have their batteries charged wirelessly without the use of conductors. The most common form of wireless power transfer includes electrodynamic induction. Electrodynamic induction represents a near field wireless transmission of electrical energy between a wireless power transmitter and a wireless power receiver, such as a mobile communication device to provide an example. The wireless power transmitter and the wireless power receiver are tuned to similar resonant frequencies to allow the transmission of electrical energy between them. Often times, the electrical energy transmitted from the wireless power transmitter is used to charge batteries within the wireless power receiver.

Manufacturers have begun to develop wireless power transfer stations, also referred to as power pads, to bring the concept of wireless power transtfer to the consumer. These wireless power transfer stations allow the consumer to wirelessly charge one or many wireless power transfer enabled devices, such as mobile communication devices or mobile computing devices to provide some examples, by placing these wireless power transfer enabled devices proximate to the wireless power transfer stations. This alleviates the need for the consumers to physically plug each of their devices into a wall outlet for charging.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 illustrates an exemplary wireless power transfer environment.

FIG. 2 illustrates a block diagram of an exemplary wireless power transfer station.

FIG. 3 illustrates a block diagram of an exemplary coil module and load detection module.

FIG. 4A is a circuit diagram of rectifier operating in full bridge mode.

FIG. 4B is a circuit diagram of rectifier operating in half bridge mode.

FIG. 4C shows a waveform diagram of rectifier operating in full bridge mode.

FIG. 4D shows a waveform diagram of rectifier operating in half bridge mode.

FIG. 5 shows a diagram of a system for bootstrapping a bias supply and switching to a lower voltage domain to conserve power in a wireless power transfer system.

FIG. 6 illustrates a block diagram of an exemplary WPT enabled communication device according to an exemplary embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment.” “an example embodiment.” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of this discussion, the term “module” shall be understood to include at least one of software, firmware, and hardware (such as one or more circuits, microchips, processors, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

### OVERVIEW

A wireless power transfer (WPT) station is disclosed for wirelessly transferring power to a WPT enabled device. To initiate charging of the WPT enabled device, the WPT enabled device is simply moved to be proximate to the WPT station. After an initialization and setup period, the WPT station transmits power transfer signals to the WPT enabled device. The WPT enabled device receives the transferred power transfer signals, typically through inductive coupling, and extracts a voltage and/or current therefrom for charging. The extracted voltage and/or current can then be rectified and/or regulated by the WPT enabled device to produce a charging voltage and/or charging current that can be stored in a power storage element, such as a battery or a capacitor to provide some examples, of the WPT enabled device.

Exemplary Wireless Power Transfer Environment

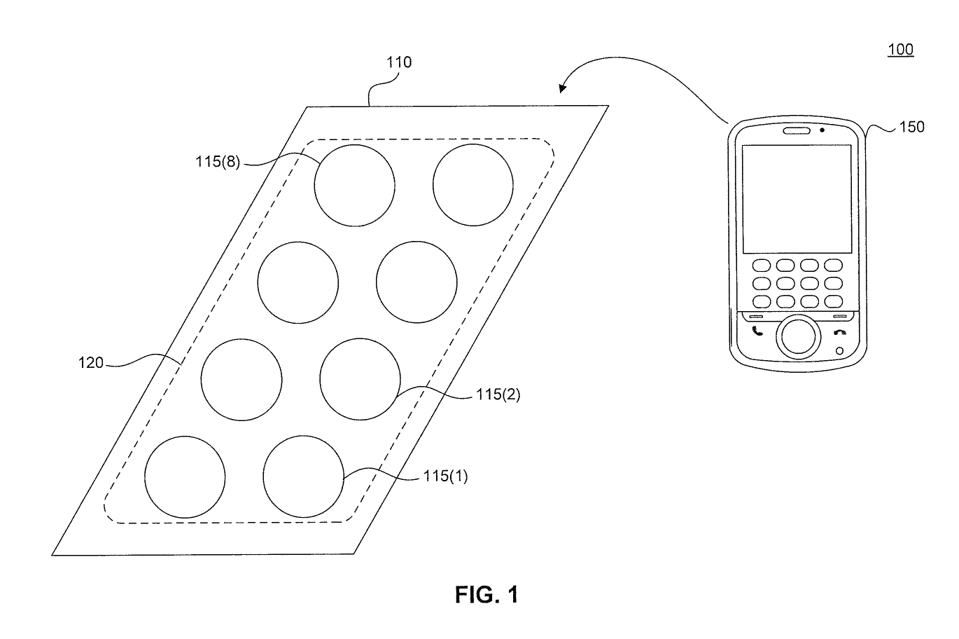

FIG. 1 illustrates an exemplary wireless power transfer (WPT) environment according to an exemplary embodiment of the present disclosure. The WPT environment 100 includes a WPT station 110 having coils 115(1) through 115(8) that arranged in a grid or matrix pattern. However, the number of coils 115(1) through 115(8) and their arrangement in the grid or matrix pattern are for illustrative purposes only. Those skilled in the relevant art(s) will recognize that the WPT station 110 can include a different number of coils and/or a different arrangement of coils without departing from the spirit and scope of the present disclosure. The coils 115(1) through 115(8) communicate various signals between the WPT station 110 and a WPT enabled device 150. These signals can include commands and/or other communications, and can be used to transfer power from the WPT station 110 to the WPT enabled device 150. In an embodiment, the WPT station 110 can include an outer coil 120. The outer coil 120 is disposed around a perimeter of the WPT station 110, or, alternatively, around one or more of the coils 115(1) through 115(8). The outer coil 120 is generally larger in size when compared to each of the coils 115(1) through 115(8). This allows the WPT station 110 to communicate various signals between the WPT station 110 and the WPT enabled device 150 at a greater distance than the each of the coils 115(1) through 115(8).

To initiate charging of the WPT enabled device 150, the WPT enabled device 150 is simply moved to be proximate to the WPT enabled device 150. After an initialization and setup period, the WPT station 110 transmits power transfer signals from one or more of the coils 115(1) through 115(8) to the WPT enabled device 150. The WPT enabled device 150 receives the transferred power transfer signals, typically through inductive coupling, and extracts a voltage and/or current therefrom for charging. In this manner, the WPT station 110 functions as a power transmitter and the WPT enabled device 150 functions as a power receiver. In embodiments, the wireless power transfer is implemented as a magnetic coil-to-coil power transfer using one or more transmit coils within the WPT station 110 and one or more receive coils within the WPT enabled device 150. The one or more transmit coils of the WPT station 110 are excited with a current to produce a magnetic field that induces a secondary current in the one or more receive coils of the WPT enabled device 150 when the one or more receive coils are sufficiently proximate to the one or more transmit coils. When the one or more receive coils are sufficiently proximate to the one or more transmit coils, the current is inductively transferred from the one or more transmit coils to the one or more receive coils. The secondary current can then be rectified and/or regulated by the WPT enabled device 150 to produce a charging voltage and/or charging current that can be stored in a power storage element, such as a battery or a capacitor to provide some examples, of the WPT enabled device 150.

Exemplary WPT Station

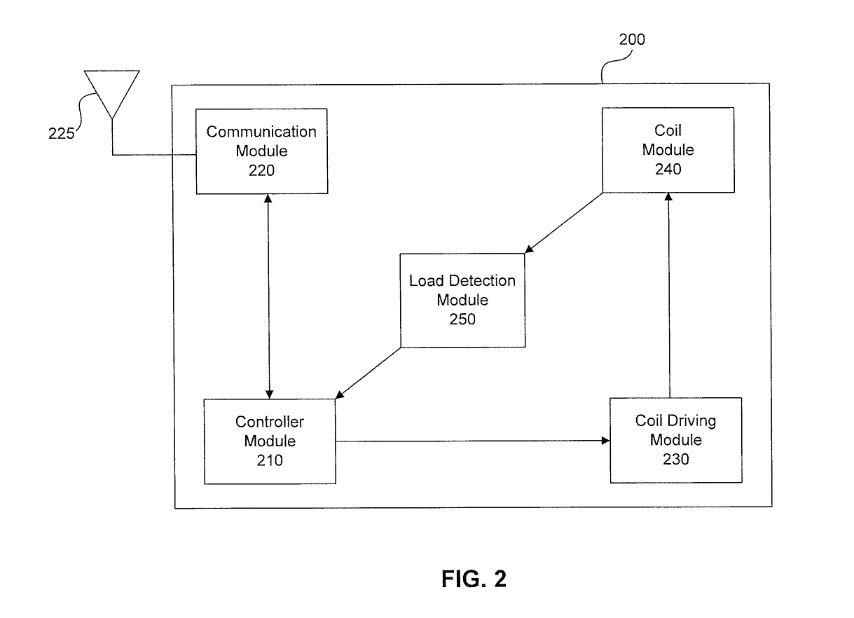

FIG. 2 illustrates a block diagram of an exemplary WPT station according to an exemplary embodiment of the present disclosure. A WPT station 200 can transfer power to a WPT enabled device, such as the WPT enabled device 150 to provide an example, and can communicate commands and/or other communications between itself and the WPT enabled device. The WPT station 200 includes a controller module 210, a communication module 220, a coil driving module 230, a coil module 240, and a load detection module 250. The WPT station 200 can represent an exemplary embodiment of the WPT station 110.

The controller module 210 controls overall operation and/or configuration of the WPT station 200. The controller module 210 can receive information from a user interface such as a touch-screen display, an alphanumeric keypad, a microphone, a mouse, a speaker, and/or from other electrical devices or host devices that are coupled to the WPT station 200. The controller module 210 can provide this information to the communication module 220, the coil driving module 230, the coil module 240, and/or the load detection module 250. Additionally, the controller module 210 can receive information from the communication module 220, the coil driving module 230, the coil module 240, and/or the load detection module 250. The controller module 210 can provide this information to the user interface, to other electrical devices or host devices, and/or to the communication module 220, the coil driving module 230, the coil module 240, and/or the load detection module 250. Further, the controller module 210 can include a memory to store executable instructions and/or program code. The controller module 210 can include a processor to execute these instructions and/or program code to control overall configuration and/or operation of the WPT station 200. Various exemplary operations of the controller module 210 are to be described in further detail below. It should be noted that these exemplary operations are not limiting, those skilled in the relevant art(s) will recognize that other operations are possible without departing from the spirit and scope of the present disclosure. These other operations can include communicating with the WPT enabled device or another communication device, processing various signals from one or more coils of the coil module 240, and/or causing various signals to be loaded onto the one or more coils to provide some examples.

The communication module 220 can communicate commands and/or other communications between itself and the WPT enabled device or another communication device in accordance with one or more long range communication standards or protocols and/or one or more short range communication standards. The one or more long range communication standards or protocols can include a cellular communication standard or protocol, such as a third Generation Partnership Project (3GPP) Long Term Evolution (LTE) communication standard, a fourth generation (4G) mobile communication standard, a third generation (3G) mobile communication standard to provide some examples, a wireless networking standard or protocol, such as an Institute of Electrical and Electronics Engineers (IEEE) 802.11 communication standard to provide an example, and/or any other long range communication standard or protocol that will be apparent to those skilled in the relevant art(s) without departing from the spirit and scope of the present disclosure. The one or more short range communication standards or protocols can include Bluetooth or Bluetooth Low Energy (BLE) standards, infrared, optical, ultrasonic, near field communication (NFC), radio-frequency identification (RFID), any other short range communication standard or protocol that will be apparent to those skilled in the relevant art(s) without departing from the spirit and scope of the present disclosure. As illustrated in FIG. 2, communication module 220 is coupled to an antenna module 225. The antenna module 225 operates as an interface between the communication module 220 and the WPT enabled device or the other communication device.

The coil driving module 230 operates as an interface between the controller module 210 and the coil module 240. The coil driving module 230 converts various signals from a first format provided by the controller module 210 into a second format that is suitable for use by the coil module 240 for transmission to the WPT enabled device. For example, the coil driving module 230 can include one or more amplifiers or level converters to provide some examples to convert the various signals provided by the controller module 210 from being a first current level and/or first voltage level to a second current level and/or voltage level that is suitable for use by the coil module 240 for transmission to the WPT enabled device. Optionally, the coil driving module 230 can modulate the various signals provided by the controller module 210 in accordance with a suitable analog or digital modulation technique to make them more suitable for use by the coil module 240 for transmission to the WPT enabled device. The suitable analog or digital modulation technique may include amplitude modulation (AM), frequency modulation (FM), phase modulation (PM), phase shift keying (PSK), frequency shift keying (FSK), amplitude shift keying (ASK), quadrature amplitude modulation (QAM) and/or any other suitable modulation technique that will be apparent to those skilled in the relevant art(s).

In an exemplary embodiment, the coil driving module 230 can operate in an active communication mode and/or a passive communication mode. The coil driving module 230 modulates information from the controller module 210 onto a carrier wave, referred to as a modulated information communication, and provides this modulated information communication to the coil module 240 which, in turn, generates a first magnetic field. The coil module 240 ceases to generate the first magnetic field after transferring the information to the WPT enabled device in the active communication mode. Alternatively, in the passive communication mode, the coil driving module 230 continues to provide the first carrier wave without the information, referred to as an unmodulated information communication, to the coil module 240 once the information has been transferred to the WPT enabled device.

Additionally, the coil driving module 230 converts various signals from a first format provided by the coil module 240 into a second format that is suitable for use by the controller module 210. For example, the coil driving module 230 can include one or more amplifiers or level converters to provide some examples to convert the various signals provided by the coil module 240 from being a first current level and/or first voltage level to a second current level and/or voltage level that is suitable for use by the controller module 210. Optionally, the coil driving module 230 can demodulate the various signals provided by the coil module 240 in accordance with the suitable analog or digital modulation technique to make them more suitable for use by the controller module 210.

The coil module 240 includes the one or more coils to communicate with the WPT enabled device. The coil driving module 230 can provide various signals to the one or more coils to generate the magnetic field. These various signals can simply be used to provide WPT to the WPT enabled device, or these various signal can, optionally, include information that is communicated to the WPT enabled device. The WPT enabled device can also induce a second magnetic field onto the one or more coils when the WPT station 200 is operating in the active communication mode to transfer information from the WPT enabled device to the WPT station 200. Alternatively, the WPT enabled device can load modulate the magnetic field being provided by the one or more coils when the WPT station 200 is operating in the passive communication mode to transfer the information from the WPT enabled device to the WPT station 200.

The load detection module 250 detects for the presence of the WPT enabled device in the magnetic field and indicates to the controller module 210 when the WPT enabled device is present. For example, the load detection module 250 can include a detector to determine one or more signal metrics, such as an amount of current flowing through the one or more coils to provide an example, corresponding to the magnetic field being provided by the one or more coils of the coil module 240. Thereafter, the load detection module 250 can include a comparator to compare the one or more signal metrics to one or more previously determined signal metrics. The load detection module 250 determines the WPT enabled device is present when the one or more signal metrics substantially differs from the one or more previously determined signal metrics. This difference indicates that the WPT enabled device has altered or disturbed the magnetic field and is present. In an exemplary embodiment, the load detection module 250 indicates that the WPT enabled device is present in the magnetic field when the one or more signal metrics and the one or more previously determined signal metrics differ by a threshold. Additionally, the load detection module 250 can use the one or more signal metrics to determine various load characteristics of the one or more coils of the coil module 240. Differences between these load characteristics can indicate a relative location of the WPT enabled device to the WPT station 200. For example, some of the coils may be loaded more than other coils indicating that the WPT enabled device is closer to these more heavily loaded coils than other lightly loaded coils.

Discovery Operation

The WPT station 200 can detect a presence of the WPT enabled device through a discovery operation. The WPT station 200 can transmit a ping signal on more than two coils of the coil module 240 simultaneously or substantially simultaneously. This simultaneous, or near simultaneous, transmission of the ping signal by more than two of the coils of the coil module 240 increases signal strength of the ping signal. This provides a greater chance that the WPT enabled device will detect the ping signal and respond to the ping signal accordingly. In an embodiment, the ping signal can be transmitted over a subset coils of the coil module 240 simultaneously. The subset of coils should include at least two coils, and all coils within the subset should be adjacent to at least one other coil within the subset. In this manner, the ping signal can be transmitted with increased signal strength while maintaining at least some of the coils of the coil module 240 in a power transfer or low-power state.

In an embodiment, the WPT station 200 transmits different ping signals depending on whether the WPT enabled device has been detected. For example, prior to detection of the WPT enabled device, the WPT station 200 may transmit “short” pings. The short ping may be a reduced power unmodulated signal to enable fast multimode detection by the WPT enabled device. The duration of the short ping can be, for example, 1 msec, although other durations could be used. An interval of approximately 50 msec may be sufficient in some applications, although other durations could be used. When the short ping is detected by the WPT enabled device, the WPT enabled device may notify the WPT station 200 of its presence through load modulation.

When the WPT station 200 detects a change in its load due to the load modulation caused by the WPT enabled device, the WPT station 200 can then switch to an “extended” ping. The extended ping should have a duration that allows for sufficient energy transfer for the WPT enabled device to wake up and perform setup. The duration of the extended ping may be 50-100 msec, for example. By switching to the extended ping after the WPT enabled device is detected, power can be conserved while still scanning the environment for other WPT enabled devices through use of the short ping.

In an embodiment, one or more WPT enabled devices, such as one or more of WPT enabled devices 150 to provide an example, may be charging on the WPT station 200. From an earlier initiation, or based on loads detected by the load detection module 250, the WPT station 200 should be aware of the coils of the coil module 240 that are occupied in charging the one or more WPT enabled devices. Therefore, using this information, the controller module 210 instructs the coil driving module 230 to transmit the ping signal via one or more of the remaining coils within the coil module 240. For example, the controller module 210 can instruct the coil driving module 230 to transmit the ping signal on all unused coils, or a group of the unused coils.

By modulating ping signals onto the coils, each of the above scenarios employs load modulation for sending the ping. However, as an alternative, the WPT station 200 may employ an independent wireless communication system for initiating communication with the WPT enabled devices. For example, in an embodiment, the controller module 210 of the WPT station 200 may generate a ping signal, which it forwards to the communication module 220. The communication module 220 then transmits the ping signal via the antenna 225 using one or more of its communication standards and/protocols. In an embodiment, the communication standards and/protocols used for discovery can change based on one or more parameters. For example, the WPT station 200 may select at least one of the communication module 220 or the coils of the coil module 240 for transmitting the ping signal depending on the time, coil position of the coils of the coil module 240 with respect to the WPT enabled device, desired communication protocol, etc. During periods when the coils of the coil module 240 are not being used to transmit the ping signals, they can be turned off unless otherwise being utilized.

To provide an example, before the WPT enabled device has been detected, the WPT station 200 may utilize the communication module 220 to transmit the ping in order to achieve increased range. The communication module 220 can determine proximity of the WPT enabled device based on one or more of several parameters, including signal strength, time of response, and triangulation. When the WPT enabled device is within a predetermined proximity, the WPT station 200 may switch to the coils of the coil module 240 combine the ping with other preliminary setup functions performed by the coils of the coil module 240 (e.g., coil alignment, etc.). In this manner, the coils of the coil module 240 can be kept in an idle state until the WPT enabled device is in range of receiving their communications. To provide another example, the communication module 220 could periodically be used in order to assist with device alignment. In particular, if the WPT enabled device is not properly aligned with one or more of the coils of the coil module 240, it may be unable to receive WPT communications. Therefore, periodically using the communication module 220 can assist the alignment procedure.

In an embodiment, the WPT enabled device could instead transmit a notification signal to notify the WPT station 200 of its presence. For example, a parameter, such as a user instruction, a power level of the receiving device, etc. can cause the WPT enabled device to transmit the ping signal to the environment. When sufficiently close the WPT station 200, this ping signal can be received by at least one of the communication module 200 and the coils of the coil module 240. The received ping signal can be forwarded to, and deciphered by, the controller module 210. Once deciphered, the controller module 210 controls at least one of the communication module 220 and the coils of the coil module 240 to communicate with the WPT enabled device to perform preliminary setup, etc. For example, the controller module 210 can cause the communication module 220 to transmit its ping signal in response. In this manner, charging can be quickly initiated because it is based on a demand by the WPT enabled device.

Discovery in Multi-Standard Environment

In order to be adaptable to additional standards, each of the above configurations can be slightly modified so as to allow discovery of devices that may be in a different standard. In an embodiment, the WPT station 200 can perform any of the above discovery techniques for multiple standards in succession. For example, the WPT station 200 can transmit a first standard ping signal on all coils or a group of coils of the coil module 240, and then subsequently transmit a second ping signal of the coils. Similarly, while some of the coils of the coil module 240 are being used for power transfer, other unused coils of the coil module 240 can be controlled to transmit ping signals for other standards.

In order to improve discovery, the WPT station 200 can adjust the ping signals based on the popularity or expectation of the standard. For example, a first standard may be much more widely used in devices than a second standard. In this scenario, the controller module 210 can instruct the communication module 220 and/or the coil driving module 230 to transmit the ping signal of the first standard more often than the ping signal of the second standard. The ratio among the ping signals can be adjusted based on popularity, based on the standards of devices discovered by the WPT station 200, based on user input, or based on any other statistically relevant information. In an exemplary embodiment, the WPT station 200 can transmit a universal beacon that can be detected among devices of wireless power transfer standards. The universal beacon may include a universal data packet that has its own message. The packet could include information that is necessary for nearby devices to assess their charging capabilities, such as standards supported by the WPT station 200. The universal beacon may be transmitted by the coils of the coil module 240 or the communication module 220. In this exemplary embodiment, the WPT enabled device would be configured to recognize the universal beacon. Therefore, the WPT enabled device could be configured to extract the information from the universal beacon in order to determine its power charging options. The WPT enabled device could then emit a response signal that also has a universal format in order to apprise the charging station of its parameters before beginning power transfer. Alternatively, the WPT enabled device could emit the response signal using one of the available standards identified in the universal beacon.

Increased Communication Distance

It can be desirable to increase the communication distance of the WPT station 200 in some situations. Therefore, in an embodiment, one of the coils of the coil module 240 represents an outer coil, such as the outer coil 120 to provide an example. The outer coil is disposed around a perimeter of the WPT station 200, or alternatively around a group of coils of the coil module 240, such as the coils 115(1) through 115(8) to provide an example. Due to its size, signals energized onto the outer coil can travel further than signals energized onto other, inner coils of the coil module 240, such as the coils 115(1) through 115(8) to provide an example. Consequently, when the WPT enabled device approaches the WPT station 200, the WPT enabled device can receive communications from the outer coil at an earlier time when compared to the other, inner coils of the coil module 240. In an embodiment, the outer coil can provide pings in cooperation with the other, inner coils of the coil module 240. For example, the outer coil can transmit a long-distance ping signal to notify devices which are out of range of pings transmitted by other, inner coils of the coil module 240. Following the long-distance ping, the other, inner coils of the coil module 240 can transmit one or more short-distance pings to establish better communication with devices within their range.

In another embodiment, the other, inner coils of the coil module 240 of the coil module 240 can also be configured to transmit ping signals over long distances. For example, the coil driving module 230 can drive the other, inner coils of the coil module 240 to simultaneously, or near simultaneously, transmit a high-powered ping signal. The constructive sum of the high-power pings sent from the other, inner coils of the coil module 240 can increase the transmission distance of the ping signal. In addition, this high-power simultaneous transmission by the coils of the coil module 240 can be performed with a low duty cycle to conserve power. The high-power ping transmission by the coils of the coil module 240 can be performed in addition to, or instead of, the long-distance ping generated by the outer coil 120.

In addition, the coil driving module 230 can drive the coils of the coil module 240 at different power levels and/or different duty cycles. For example, the coil driving module 230 can drive the coils of the coil module 240 to simultaneously transmit a high-power ping signal, and then to transmit a mid-power ping signal followed by a low-power ping signal. In this example, the high-power ping signal can have a lower duty signal than the other-power ping signals. Also, in this example embodiment, the high-power ping signal can be emitted with a predetermined frequency.

Preliminary Setup

Once the WPT enabled device has received the ping signal, the WPT enabled device is aware of the WPT station 200. At this time, the WPT enabled device can begin the preliminary setup with the WPT station 200. In an embodiment, the preliminary setup may include exchanging device parameters, capabilities and other information between the WPT enabled device and the WPT station 200. For example, once the WPT enabled device has received the ping from the WPT station 200, the WPT enabled device may make an internal decision regarding whether to initiate the preliminary setup. This decision may be as simple as whether the WPT station 200 is enabled of charging the WPT enabled device based on standards, power needs, etc. Once the WPT enabled device has determined to continue with the preliminary setup, the WPT enabled device responds to the WPT station 200 with the necessary information.

In an embodiment, the response can be sent to the WPT station 200 using the same or different form of wireless communication employed by the WPT station 200. For example, if the WPT enabled device received the ping through the use of load modulation, the WPT enabled device can transmit the response signal using the same protocol. Alternatively, a different protocol can be used. Communication between the devices can switch to WPT either for the immediate response signal, or after an initial setup has completed. For example, in an embodiment, the WPT station 200 begins initial communication with the WPT enabled device using NFC. The NFC standard includes its own field powering mechanism. Consequently, even when the WPT enabled device has not stored charge, the power extracted from the NFC initiation signals can provide sufficient power to the WPT enabled device to begin the setup process. Once the necessary information has been exchanged, and the setup has completed, the WPT station 200 and the WPT enabled device can switch to the WPT protocol. The signals transferred in the WPT protocol can then be used to transfer power to the WPT enabled device.

In the response, the WPT enabled device can include any information that may be relevant to the charging/connection between the WPT enabled device and the WPT station 200. For example, the WPT enabled device can report its model number, power transfer standard preferences, power needs, etc. This information is received either at the communication module 220 or the coil module 240, depending on the transmission protocol employed by the WPT enabled device, and forwarded to the controller module 210. From this information, the controller module 210 can tailor the charging characteristics employed by the WPT station 200. For example, based on the model number of the WPT enabled device, the controller module 210 can access stored data relating to that model in order to improve charging. This data may include thermal properties, metal layouts, shielding properties and expected interferences, among others. This data may have many additional uses, such as improving foreign object detection, for example.

Coil Selection

After performing the preliminary setup, the WPT enabled device can be brought in close proximity with the WPT station 200. At this time, and particularly when the WPT enabled device is proximate to the WPT station 200, coil selection should be performed to select coils of the coil module 240 that have preferred power transfer characteristics. In other words, the WPT enabled device may only overlap a small number of the coils of the coil module 240. Therefore, the coil module 240 that are successfully and efficiently transferring power to the WPT enabled device should be selected to maintain efficiency and conserve power. Meanwhile, coils of the coil module 240 that are inefficiently transferring power, or not transferring power, to the WPT enabled device can be placed in a low-power or off state.

In an embodiment, the WPT enabled device sends an “awake notification” in response to the ping received from the WPT station 200, and the coil selection follows thereafter and may be combined with the preliminary setup (particular when the preliminary setup is performed using WPT communications). In an embodiment where another wireless communication protocol is being used to communicate between the WPT station 200 and the WPT enabled device, the WPT station 200 can determine when to initiate the coil selection based on a signal strength of the response received from the WPT enabled device.

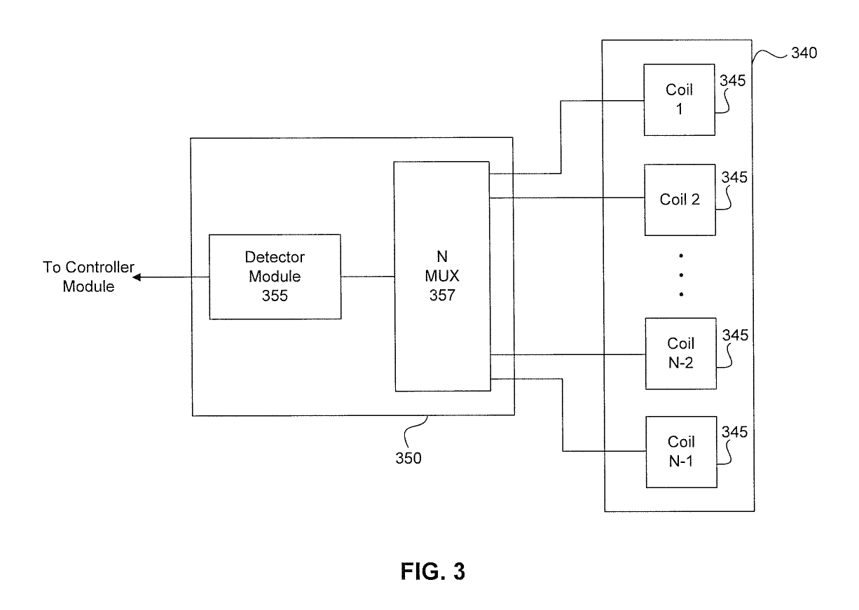

FIG. 3 illustrates a block diagram of an exemplary coil module 340 and load detection module 350. The coil module 340 includes a plurality of coils 345 and may represent an exemplary embodiment of the coil module 240, and the load detection module 340 includes a detector module 355 and a multiplexer 357, and may represent an exemplary embodiment of the load detection module 240.

In an embodiment, once the coil selection process begins, the WPT station 200 energizes the coils 345 to listen for a response sent from the WPT enabled device. For example, the coils 345 are enabled of receiving responses from the WPT enabled device using load modulation. The WPT enabled load modulates the magnetic field provided by the coils 345 with the response, which is detected by one or more of the coils 345. Each of the coils 345 is connected to the detector module 355 by the multiplexer 357. The multiplexer 357 is an N multiplexer corresponding to the N coils 345. The response can be the detection of a load on one or more energized coils.

As the coils 345 are receiving the response signal from the WPT enabled device, the multiplexer 357 selects one of the coils 345 (e.g., coil 1). The detector module 355 receives the response signal received by the selected coil and forwards the signal to the controller module 210. The multiplexer 357 subsequently selects each of the remaining coils 345, thereby allowing the response received by each of the remaining coils to be detected by the detector module and forwarded to the controller module 210.

After receiving the responses from each of the coils 345, the controller module 210 performs signal analysis on the received responses to determine coupling coefficients between each of the coils 345 and the WPT enabled device. The signal analysis may include calculating signal strengths, signal envelope analysis, among other analysis techniques. From the analysis, the controller module 210 can determine which of the coils 345 have the preferred coupling coefficient with the WPT enabled device. The controller module 210 then selects one or more of the coils 345 based on the coupling coefficients and instructs the coil driving module 230 to drive the selected coils to transfer power to the WPT enabled device.

Exemplary WPT Enabled Communication Device

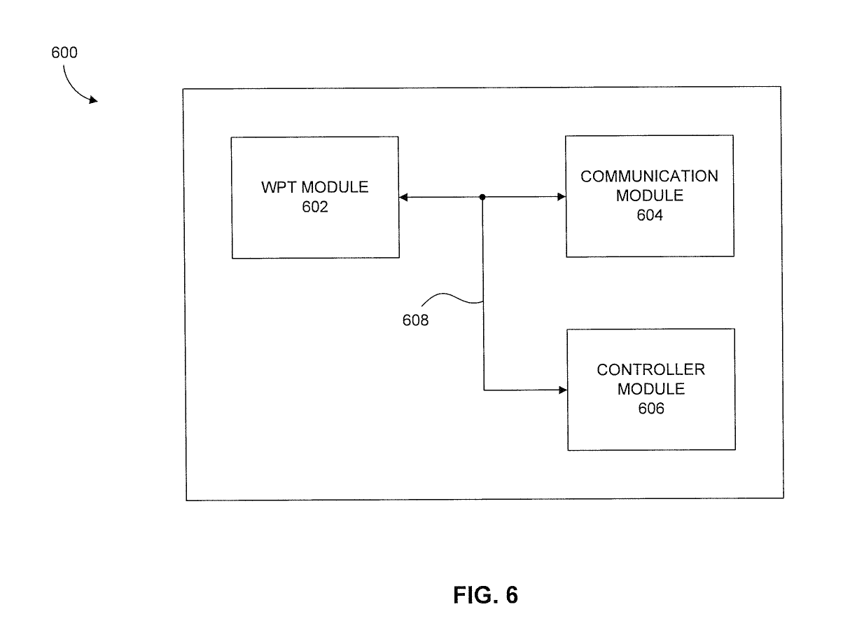

FIG. 6 illustrates a block diagram of an exemplary WPT enabled communication device according to an exemplary embodiment of the present disclosure. A WPT enabled communication device 600 communicates information over wired and/or wireless communication networks in accordance with various communication standards. The WPT enabled communication device 600 can represent a mobile communication device, such as a cellular phone or a smartphone, a mobile computing device, such as a tablet computer or a laptop computer, or any other electronic device that is enabled of communicating information over communication networks that will be apparent to those skilled in the relevant art(s) without departing from the spirit and scope of the present invention. The WPT enabled communication device 600 can include a wireless power transfer (WPT) module 602, a communication module 604, a controller module 606, or any combination thereof which are communicatively coupled to one another via a communication interface 608. Additionally, those skilled in the relevant art(s) will also recognize that the WPT module 602, the communication module 604, and/or the host processor 608 need not be communicatively coupled to one another via the communication interface 608. In these situations, those modules that are communicatively coupled to the communication interface 608 can independently communicate with other communication enabled devices without internal communication. The WPT enabled communication device 600 can represent an exemplary embodiment of the WPT enabled communication device 150.

The WPT module 602 supports WPT from a WPT station, such as the WPT station 110 or the WPT station 200 to provide some examples. The WPT enabled communication device 600 is simply moved to be proximate to the WPT station to initiate charging. After the initialization and setup period, the WPT module 602 receives power transfer signals from the WPT station. The WPT module 602 receives the transferred power transfer signals, typically through inductive coupling, and extracts a voltage and/or current therefrom for charging. In embodiments, the wireless power transfer is implemented as a magnetic coil-to-coil power transfer using one or more transmit coils within the WPT station and one or more receive coils within the WPT module 602. The transmit coil of the WPT station is excited with a current to produce a magnetic field that induces a secondary current in the receive coil of the WPT module 602 when the receive coil is sufficiently proximate to the transmit coil. The secondary current can then be rectified and/or regulated by the WPT module 602 to produce a charging voltage and/or charging current that can be stored in a power storage element, such as a battery or a capacitor to provide some examples, of the WPT module 602.

In an exemplary embodiment, the WPT module 602 can receive one or more ping signals from the WPT station during discovery. Thereafter, the WPT module 602 and the WPT station can exchange device parameters, capabilities and other information between the WPT station and the WPT enabled communication device 600. For example, once the WPT module 602 has received the ping from the WPT station, the WPT module 602 may make an internal decision regarding whether to initiate the preliminary setup. This decision may be as simple as whether the WPT station is enabled of charging the WPT enabled device based on standards, power needs, etc. Once the WPT module 602 has determined to continue with the preliminary setup, the WPT module 602 responds to the WPT station with the necessary information.

In an embodiment, the response can be sent to the WPT station using the same or different form of wireless communication employed by the WPT station. For example, if the WPT module 602 received the ping through the use of load modulation, the WPT module 602 can transmit the response signal using the same protocol. Alternatively, a different protocol can be used. Communication between the devices can switch to WPT either for the immediate response signal, or after an initial setup has completed. Once the necessary information has been exchanged, and the setup has completed, the WPT station 200 and the WPT enabled device can switch to the WPT protocol. The signals transferred in the WPT protocol can then be used to transfer power to the WPT enabled device. In the response, the WPT module 602 can include any information that may be relevant to the charging/connection between the WPT module 602 and the WPT station. For example, the WPT module 602 can report its model number, power transfer standard preferences, power needs, etc.

The communication module 604 can communicate commands and/or other communications between itself and the WPT station or another communication device in accordance with one or more long range communication standards or protocols and/or one or more short range communication standards. The one or more long range communication standards or protocols can include a cellular communication standard or protocol, such as a third Generation Partnership Project (3GPP) Long Term Evolution (LTE) communication standard, a fourth generation (4G) mobile communication standard, a third generation (3G) mobile communication standard to provide some examples, a wireless networking standard or protocol, such as an Institute of Electrical and Electronics Engineers (IEEE) 802.11 communication standard to provide an example, and/or any other long range communication standard or protocol that will be apparent to those skilled in the relevant art(s) without departing from the spirit and scope of the present disclosure. The one or more short range communication standards or protocols can include Bluetooth or Bluetooth Low Energy (BLE) standards, infrared, optical, ultrasonic, near field communication (NFC), radio-frequency identification (RFID), any other short range communication standard or protocol that will be apparent to those skilled in the relevant art(s) without departing from the spirit and scope of the present disclosure.

The controller module 606 controls overall operation and/or configuration of the WPT enabled communication device 600. The controller module 606 can receive information from a user interface such as a touch-screen display, an alphanumeric keypad, a microphone, a mouse, a speaker, and/or from other electrical devices or host devices that are coupled to the WPT enabled communication device 600. The controller module 606 can provide this information to the WPT module 602 and/or the communication module 604. Additionally, the controller module 606 can receive information from the wireless WPT module 602 and/or the communication module 604. The controller module 606 can provide this information to the user interface, to other electrical devices or host devices, and/or to the wireless WPT module 602 and/or the communication module 604. Further, the controller module 606 can include a memory to store executable instructions and/or program code. The controller module 606 can include a processor to execute these instructions and/or program code to control overall configuration and/or operation of the WPT enabled communication device 600.

Bridge Rectifiers for a Wireless Power Transfer System

Wireless power systems are designed to provide power wirelessly via a loosely coupled transformer, which may also be described as a transmit and receive antenna pair. The transmitter in a WPT system is typically encased in a flat pad or other appropriately formed unit (e.g., in WPT station 200). The receiver in the WPT system is typically embedded inside the unit to be powered or, in the case of a battery operated device, charged (e.g., in WPT enabled device 150 or the WPT enabled communication device 600).

In an embodiment, to power internal low voltage electronics, the receiving device (e.g., WPT enabled device 150) rectifies the signal generated at its input before regulating the voltage to a useful voltage level. The field strength of the transmitting device (e.g., WPT station 200) may not be uniform over its radiating surface. Thus, the receiving devices being powered or charged should be able to anticipate and operate with a large variation in the equivalent voltage presented to the input of the rectifier. The receiving device should be able to limit the voltage presented to the rectifier to avoid damage to circuitry in the receiving device. The receiving device can instruct the transmitting device to reduce the field strength via a communication channel so that circuitry in the receiving device is not damaged.

In an embodiment, the transmitting device (e.g., WPT station 200) is used to charge one or more devices simultaneously. In the event that a first device experiences a field strength high enough to cause damage to internal circuitry, the first device can request that the transmit field strength be reduced. If a second device also being remotely powered is situated in a weaker section of the field, the act of reducing the field strength may cause the second device to receive insufficient equivalent voltage for the second device to operate correctly and receive power.

Systems and methods of the present disclosure provide a rectifier that can operate over a large range of input field strengths. A rectifier according to embodiments of the present disclosure can operate in a full bridge mode when the input field strength is high or a half bridge mode when the input field strength is low. When operating in the full bridge mode, the rectifier produces a voltage proportional to the field strength. When operating in the half bridge mode, the rectifier produces a voltage proportional to two times the field strength (or two times the voltage produced by the rectifier operating in full bridge mode). In an embodiment, the rectifier incorporates a mode switch, which can be used to select full bridge or half bridge mode depending on the voltage measured at the output of the rectifier.

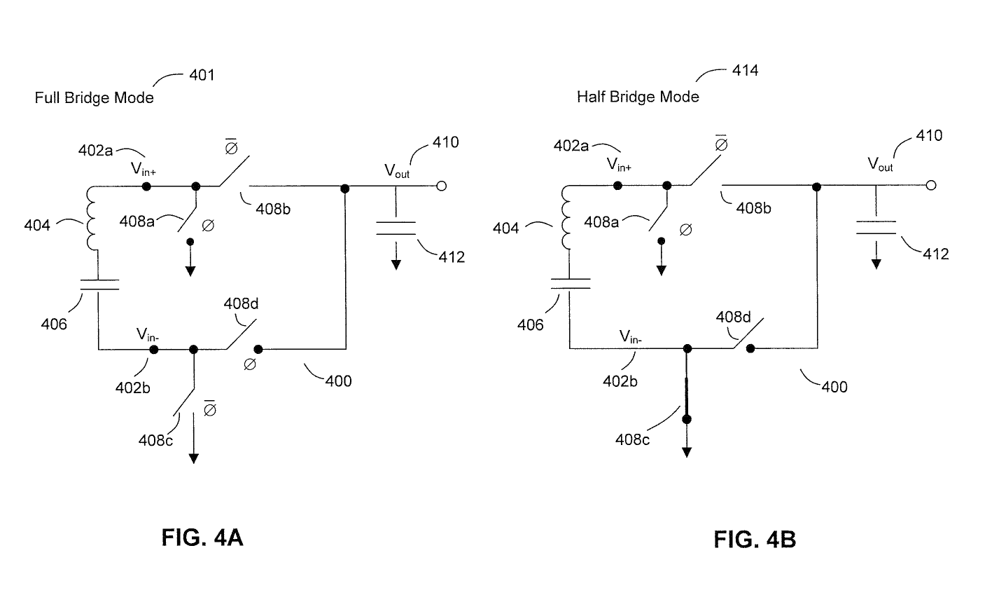

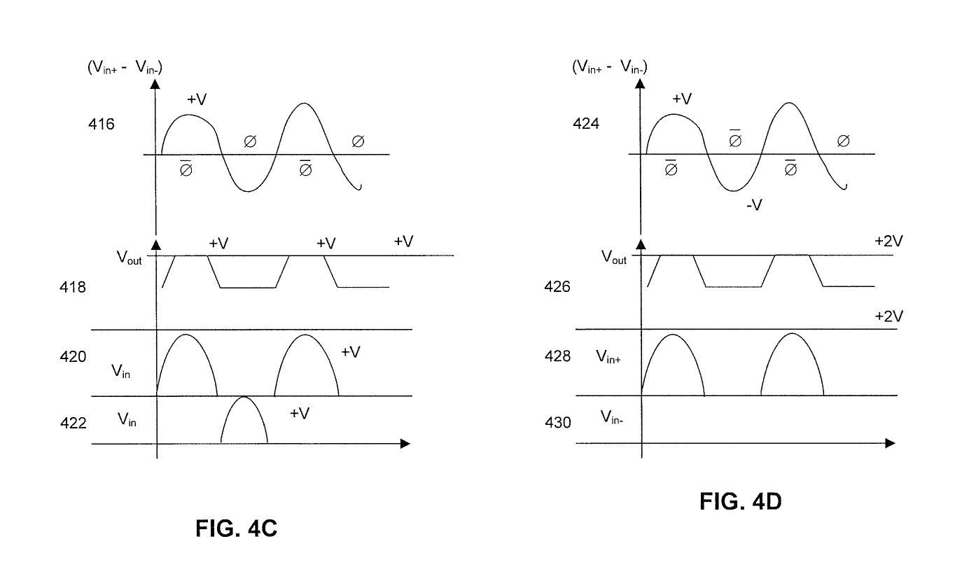

FIGS. 4A and 4B show circuit diagrams of a rectifier 400. FIG. 4A is a circuit diagram of rectifier 400 operating in full bridge mode 401. FIG. 4B is a circuit diagram of rectifier 400 operating in half bridge mode 414. In an embodiment, rectifier 400 can be implemented in a receiving device (e.g., WPT enabled device 150) of a WPT system. Rectifier 400 includes an inductor 404, a first capacitor 406, a second capacitor 412, and a plurality of switches 408. In an embodiment, inductor 404 and a capacitor 406 are used to receive power from a transmitting device (e.g., WPT station 200) and generate an input voltage 402. Using switches 408, rectifier 400 converts an alternating current received from the transmitting device to a stable direct current used to power circuitry in the receiving device. The rectifier generates a direct current output voltage 410.

Alternating current (AC) signals periodically reverse direction in the flow of electric charge. Thus, an AC signal has a component with a positive component and a negative component. As the flow of electric charge of the received AC input voltage 402 changes, rectifier 400 can closes or open switches 408 to rectify the signal.

In an embodiment, switches 408c and 408d can be used to control the mode of rectifier 400 by maintaining switch 408c in a closed state and switch 408d in an open state. When switches 408c and 408d are allowed to open and close as the flow of electric charge of input voltage 402 changes, as shown in FIG. 4A, rectifier 400 operates in full bridge mode 401. When switch 408c is maintained in a closed state and switch 408d is maintained in an open state as the flow of electric charge of input voltage 402 changes, as shown in FIG. 4B, rectifier 400 operates in half bridge mode 414. When rectifier 400 is operating in full bridge mode 401, rectifier 400 converts the whole input signal 402 to an output signal 410 with constant polarity (either positive or negative). When rectifier 400 is operating in half bridge mode 414, either the positive or negative half of the input alternating current waveform 402 is passed, and the other half of the input waveform 402 is blocked.

FIG. 4C shows a waveform diagram of rectifier 400 operating in full bridge mode 401. Waveform 416 shows the positive and negative components of input voltage 402. Waveform 418 shows the output voltage 410 generated by passing the positive components 420 of input signal 402 and converting the negative components of input signal 402 into components with a positive polarity 422. In an embodiment, when the input voltage 402 is positive, switches 408b and 408c are closed, and switches 408a and 408d are open. This switch configuration allows the positive components 420 of the input voltage 402 to flow to the output 410. In an embodiment, when the input voltage 402 is negative, switches 408b and 408c are open, and switches 408a and 408d are closed. This switch configuration reverses the polarity of the negative components of the input voltage 402.

FIG. 4D shows a waveform diagram of rectifier 400 operating in half bridge mode 414. Waveform 424 shows the positive and negative components of input voltage 402. Waveform 426 shows the output voltage 410 generated by passing the positive components 428 of input signal 402 and passing 430 the negative components of input signal 402. In half bridge mode 414, switch 408c is maintained in a closed state, and switch 408d is maintained in an open state. In an embodiment, when the input voltage 402 is positive, switches 408b is closed, and switch 408a is open. This switch configuration allows the positive components 428 of the input voltage 402 to flow to the output 410. In an embodiment, when the input voltage 402 is negative, switch 408b is open, and switch 408c is closed. This switch configuration passes the negative components of the input voltage 402.

The half bridge/voltage doubling mode 414 is more efficient than the full bridge mode 401 at lower field strengths (or equivalent input voltages). Conversely, the full bridge mode 401 is more efficient than the half bridge mode 414 at higher field strengths (or equivalent input voltages). Using these modes, rectifier efficiency is maintained over a much higher range of input field strength than a single mode rectifier. Due to the higher tolerance of input field strength, this architecture alleviates the constraints on receive antenna design and matching while still maintaining efficiency.

It should also be understood that rectifier 400 can be configured to operate in more than two rectifier modes in accordance with embodiments of the present disclosure. For example, in an embodiment, rectifier 400 can be configured to operate as a voltage tripler or a voltage quadrupler.

Bootstrap System for a Buck Regulator Output

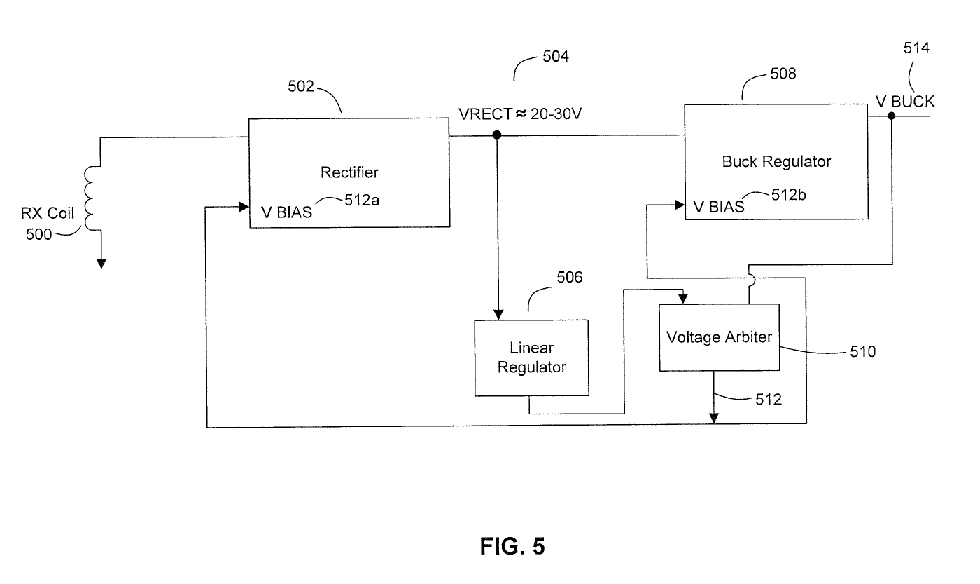

In a wireless power transfer (WPT) system, the receiver subsystem (e.g., of WPT enabled device 150) can be configured to power up in a careful sequence. FIG. 5 shows a diagram of a system for bootstrapping a bias supply and switching to a lower voltage domain to conserve power in a wireless power transfer system.

The system of FIG. 5 includes a receive coil 500, a rectifier 502, a linear regulator 506, a buck regulator 508, and a voltage arbiter 510. Rectifier 502 receives an input signal from receive coil 500 and creates a poorly regulated DC voltage at its output 504 (in an embodiment, approximately 20-30V). The output of rectifier 502 is coupled to Buck regulator 508 and linear regulator 506.

During ramp-up, the primary power supply for the whole system is effectively the output voltage 504 of the rectifier 502, as any lower bias voltages from the Buck Regulator 508 or the linear regulator 506 will not be available until sometime after the rectifier 502 has settled. Using the voltage output from rectifier 502 has a disadvantage, as the rectifier output may be a very high voltage (e.g., on the order of 20-30V). As bias currents are of a typically fixed value, the power dissipated is larger by a factor of the voltage produced by rectifier 502 divided by the voltage actually required.

Embodiments of the present disclosure use Buck regulator 508 and linear regulator 506 to decrease this dissipated voltage and improve efficiency. Linear regulator 506 is less inefficient than Buck regulator 508, but Buck regulator 508 requires time to settle at a stable voltage. Voltage arbiter 510 arbitrates between the outputs of linear regulator 506 and Buck regulator 508, so as to produce bias voltage 512. Voltage arbiter 510 initially selects linear regulator 506 to supply bias voltage 512. Voltage arbiter 510 detects the voltage 514 output from Buck regulator 508, and when this voltage settles to a certain (e.g., predefined) level, voltage arbiter 510 switches to Buck regulator 508 to supply bias voltage 512. Because Buck regulator 508 produces an output voltage of the order of 2-6V, switching to Buck regulator 508 effectively saves the amount power consumed. The lower bias voltage 512 can then be used to supply a bias voltage to other bias circuits in the WPT system.

### CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The representative signal processing functions described herein can be implemented in hardware, software, or some combination thereof. For instance, the signal processing functions can be implemented using computer processors, computer logic, application specific circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented as a computer program executing on a machine, as a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g. software) can be stored in a tangible non-transitory computer usable medium, computer program medium, or any storage medium that can be accessed by a computer or processor. Such media include a memory device such as a RAM or ROM, or other type of computer storage medium such as a computer disk or CD) ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, and further the invention should be defined only in accordance with the following claims and their equivalents.

What is claimed is:

1. A wireless power transfer (WPT) station for transferring power to a WPT enabled communication device, the WPT station comprising:
a coil module configured to provide a magnetic field;
a load detection module configured to detect a presence of the WPT enabled communication device in the magnetic field;
a controller module configured to exchange a parameter with the WPT enabled communication device when the WPT enabled communication device is present in the magnetic field and to select one or more coils from among a plurality of coils within the coil module for transferring the power to the WPT enabled communication device; and
a coil driving module configured to provide a charging signal to the one or more selected coils to be inductively transferred to the WPT enabled communication device using the magnetic field.

2. The WPT station of claim 1, wherein the controller module is configured to cause the coil module to provide a ping signal using the magnetic field to detect for the presence of the WPT enabled device.

3. The WPT station of claim 2, wherein the coil module is configured to apply the ping signal to more than two coils from among the plurality of coils to provide the magnetic field.

4. The WPT station of claim 2, wherein the controller module is further configured to select one or more unselected coils from among the plurality of coils for providing a second ping signal using the magnetic field to detect for a presence of another WPT enabled device.

5. The WPT station of claim 2, wherein the coil module is further configured to receive a plurality of responses to the ping signal over the plurality of coils, and
wherein the controller module is configured to select the one or more coils based upon a signal analysis of the plurality of responses.

6. The WPT station of claim 5, wherein the signal analysis comprises:
determining coupling coefficients between the plurality of coils and the WPT enabled device;
determining signal strengths of the plurality of responses; or analyzing signal envelopes of the plurality of responses.

7. The WPT station of claim 1, wherein the load detection module is configured to:
determine a signal metric corresponding to the magnetic field,
compare the signal metric to a previously determined signal metric, and
determine the WPT enabled device is present when the signal metric substantially differs from the previously determined signal metric.

8. A wireless power transfer (WPT) station for transferring power to a WPT enabled communication device, the WPT station comprising:
a communications module configured to initiate communication with the WPT enabled communication device, the communications module being configured to operate in accordance with a non-WPT communication standard or protocol;
a controller module configured to exchange a parameter with the WPT enabled communication device upon initiating communication with the WPT enabled communication device and to select one or more coils from among a plurality of coils for transferring the power to the WPT enabled communication device; and
a coil driving module configured to provide a charging signal to the one or more selected coils to be inductively transferred to the WPT enabled communication device using a magnetic field.

9. The WPT station of claim 8, wherein the controller module is configured to cause the communications module to provide a ping signal in accordance with the non-WPT communication standard or protocol.

10. The WPT station of claim 9, wherein the plurality of coils is configured to receive a plurality of responses to the ping signal, and
wherein the controller module is configured to select the one or more coils based upon a signal analysis of the plurality of responses.

11. The WPT station of claim 10, wherein the signal analysis comprises:
determining coupling coefficients between the plurality of coils and the WPT enabled device;
determining signal strengths of the plurality of responses; or
analyzing signal envelopes of the plurality of responses.

12. The WPT station of claim 8, wherein the non-WPT communication standard or protocol comprises:
a cellular communication standard or protocol; or
a wireless networking standard or protocol.

13. The WPT station of claim 8, wherein the non-WPT communication standard or protocol comprises:
a near field communication (NFC) standard or protocol.

14. The WPT station of claim 8, wherein the plurality of coils is arranged to form a grid or matrix pattern.

15. A wireless power transfer (WPT) station for transferring power to a WPT enabled communication device, the WPT station comprising:
a coil module, having a plurality of inner coils and an outer coil disposed around the plurality of inner coils, configured to provide a first magnetic field using the outer coil;
a load detection module configured to detect a presence of the WPT enabled communication device in the magnetic field;
a controller module configured to exchange a parameter with the WPT enabled communication device when the WPT enabled communication device is present in the magnetic field and to select one or more coils from among the plurality of inner coils for transferring the power to the WPT enabled communication device; and
a coil driving module configured to provide a charging signal to the one or more selected coils to be inductively transferred to the WPT enabled communication device using a second magnetic field.

16. The WPT station of claim 15, wherein the plurality of inner coils is arranged to form a grid or matrix pattern.

17. The WPT station of claim 15, wherein the controller module is configured to cause the outer coil to provide a ping signal using the magnetic field to detect for the presence of the WPT enabled device.

18. The WPT station of claim 17, wherein the plurality of inner coils is further configured to receive a plurality of responses to the ping signal, and
wherein the controller module is configured to select the one or more coils based upon a signal analysis of the plurality of responses.

19. The WPT station of claim 18, wherein the signal analysis comprises:
determining coupling coefficients between the plurality of coils and the WPT enabled device;
determining signal strengths of the plurality of responses; or
analyzing signal envelopes of the plurality of responses.

20. The WPT station of claim 15, wherein the load detection module is configured to:
determine a signal metric corresponding to the magnetic field,
compare the signal metric to a previously determined signal metric, and
determine the WPT enabled device is present when the signal metric substantially differs from the previously determined signal metric.
